(19) United States
(12) Patent Application Publication
(10) Pub. No.: US 2025/0233832 A1
(43) Pub. Date: Jul. 17, 2025

(54) MULTI-DATAPATH SUPPORT FOR LOW LATENCY TRAFFIC MANAGER

(71) Applicant: Marvell Asia Pte Ltd, Singapore (SG)

(72) Inventors: Viraj Milind ATHAVALE, Bangalore (IN); Srinivasan DK, Trichy (IN); Ashwin ALAPATI, San Jose, CA (US); William Brad MATTHEWS, Los Gatos, CA (US); Ajit Kumar JAIN, Milpitas, CA (US)

(21) Appl. No.: 19/017,020

(22) Filed: Jan. 10, 2025

Related U.S. Application Data
(60) Provisional application No. 63/620,414, filed on Jan. 12, 2024.

(51) Int. Cl. H04L 47/625; H04L 47/56

(52) U.S. Cl. CPC H04L 47/626; H04L 47/562

(57) ABSTRACT

Techniques as described herein may be implemented to support processing CT and SAF traffic. A common packet data buffer is allocated to store incoming CT and SAF packet data. SAF packet control data are directed onto a control data path with first processing engines, to arrive at a scheduler with a first latency. CT packet control data are directed onto a second control data path to arrive at the scheduler with a second latency less than the first latency after processing in the second control path by second processing engines bypassing a subset of the first processing engines. CT and SAF packet dequeue requests are generated for CT and SAF packets, respectively, using the CT and SAF packet control data and merged into a merged sequence of dequeue requests to retrieve corresponding packet data from the common packet data buffer based on the merged sequence of dequeue requests.

### CROSS-REFERENCE TO RELATED APPLICATIONS

This application claims the benefit of priority to U.S. Provisional Patent Application No. 63/620,414 filed on Jan. 12, 2024, which is hereby incorporated by reference.

### TECHNICAL FIELD

Embodiments relate generally to computer network communications, and, more specifically, to processing cut-through (CT) and store-and-forward (SAF) traffic.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Cut-through traffic may be supported by a network or by network switching device(s) therein to reduce latency and improve the speed of data transmission, which can be particularly beneficial in environments where speed or low-latency is critical, such as high-performance computing, real-time applications, data transfers within or between data centers, or time-sensitive traffic.

While cut-through switching can provide lower latency and faster packet forwarding, it comes with significant challenges. Packet re-ordering, increased latency, or inefficiencies might occur if there are frequent transitions and mixtures of cut-through and store-and-forward traffic. A dedicated cut-through network or network path can avoid some issues, but this setup may be impractical in large or complex network environments, especially in high-throughput networks.

### BRIEF DESCRIPTION OF DRAWINGS

The present inventive subject matter is illustrated by way of example, and not by way of limitation, in the figures of the accompanying drawings and in which like reference numerals refer to similar elements and in which:

FIG. 1 illustrates an example framework for processing and forwarding CT traffic and SAF traffic;

FIG. 2A illustrates example aspects of an example networking system; FIG. 2B illustrates example aspects of a network device;

FIG. 3A illustrates example operations for processing and forwarding CT traffic and SAF traffic;

FIG. 3B illustrates example packet control data path merging operations; and FIG. 4 illustrates an example process flow.

### DETAILED DESCRIPTION OF THE INVENTION

In the following description, for the purposes of explanation, numerous specific details are set forth in order to provide a thorough understanding of the present inventive subject matter. It will be apparent, however, that the present inventive subject matter may be practiced without these specific details. In other instances, well-known structures and devices are shown in block diagram form in order to avoid unnecessarily obscuring the present inventive subject matter.

### 1.0. General Overview

Techniques as described herein can be implemented or used with a network device or node such as a network (e.g., Ethernet, etc.) switch or (e.g., IP, etc.) router in a computer communication network to support both cut-through (CT) and store-and-forward (SAF) traffic sharing common resources of the network device or node. These techniques can ensure relatively low or the lowest possible time latency for the CT traffic while still maintaining relatively high performance for the SAF traffic.

In some operational scenarios, multiple linking structures may be used in a packet control data path to support queuing and dequeuing operations of SAF packets by the network device/node. These multiple linking structures in the packet control data path may be specifically designed or implemented to relatively efficiently store SAF packets to be received and forwarded by the network device/node. As used herein, the term “operation” may refer to one or more actions taken or performed by a respective specific device, device component, logic, logic component, processing engine, etc.

Under some approaches, the same or similar linking structures and/or the same or similar control data path and/or the same or similar operations on the control data path may be used in queuing and dequeuing operations that are performed with respect to CT packets. Delay matching may need to be implemented under these approaches for dequeuing the CT and SAF packets from a common buffer of an egress port, which incurs additional time latency for forwarding the CT packets due to matching CT and SAF delays.

In contrast, under techniques as described herein, a dedicated CT control data path separate from the SAF control data path is created to support queuing and dequeuing operations of the CT packets using separate linking structures, which are also separate from the multiple linking structures used in the SAF control data path. Additionally, optionally or alternatively, in some operational scenarios, the CT and SAF paths can use components selected from a superset comprising same processing components. While the specific composition of components in a respective path for CT or SAF is selected using a path-specific template such as path-specific control data structures (e.g., inter-and intra-packet linking data structures, etc.), path-specific path control data field values, etc., there may be overlapping with some of the same components being used for both CT and SAF paths.

As a result, the overall CT dequeue pipeline or control data path, even if common components may be used in both CT and SAF paths, can exhibit or produce different delays—without needing to perform delay matching in packet dequeuing operations—than the overall SAF dequeue pipeline or control data path.

To support sharing common resources of the network switch/node such as a packet data buffer of an egress port that is common for both the CT and SAF packets, a dequeue request path merge (DRPM) logic may be used to manage or avoid conflict or contention such as buffer access conflict or contention between dequeuing the CT and SAF packets for forwarding out of the egress port.

Approaches, techniques, and mechanisms are disclosed for processing cut-through (CT) and store-and-forward (SAF) traffic. In an embodiment, a common packet data buffer is allocated for an egress port to store incoming packet data that includes both CT packets and SAF packets. The CT packets and the SAF packets are to be forwarded (e.g., to the same or different destination addresses, etc.) out of the same egress port. SAF packet control data of the SAF packets are directed upon receipt onto a control data path defined by a first plurality of processing engines. The SAF control data are to arrive at a scheduling logic engine with a first latency after processing by the first plurality of processing engines. CT packet control data of the CT packets upon receipt are directed onto a second control data path. The CT control data are to arrive at the scheduling logic engine with a second latency that is less than the first latency after processing in the second control path by a second plurality of processing engines that bypasses at least one or more processing engines among the first plurality of processing engines. CT packet dequeue requests are generated for the CT packets using the CT packet control data, whereas SAF dequeue requests are generated for the SAF packets using the SAF packet control data. The CT packet dequeue requests and the SAF dequeue requests are merged into a merged sequence of dequeue requests. Packet data are retrieved from the common packet data buffer based on the merged sequence of dequeue requests.

In other aspects, the inventive subject matter encompasses computer apparatuses and/or computer-readable media configured to carry out the foregoing techniques.

### 2.0. Structural Overview

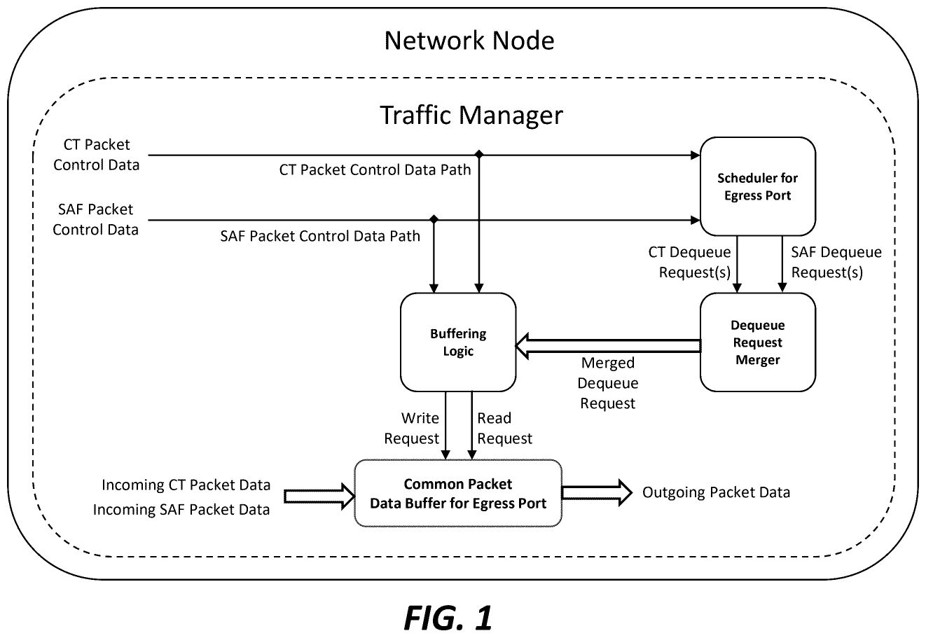

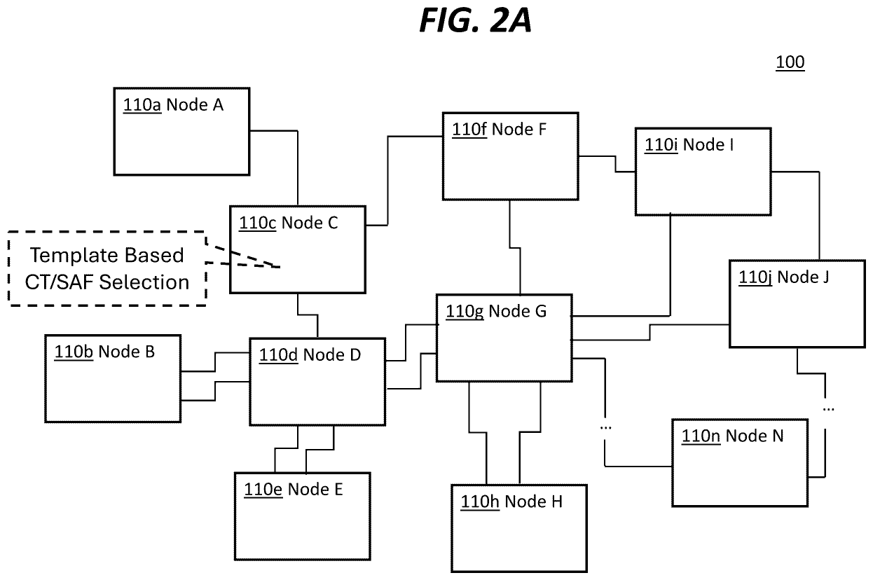

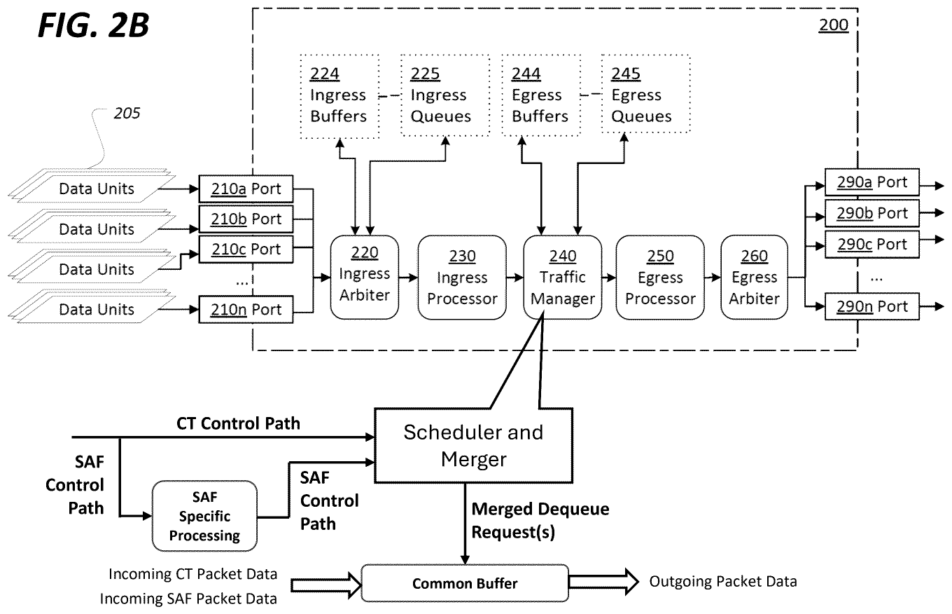

FIG. 1 illustrates an example framework for processing and forwarding CT traffic and SAF traffic that shares common resources of a network device/node in a communication network as described herein. For example, the network device/node (e.g., 110 of FIG. 2A, etc.) may be a single networking computing device (or a network device), such as a router or switch, in which some or all of the processing components described herein are implemented in application-specific integrated circuits (ASICs), field programmable gate arrays (FPGAs), or other integrated circuit(s). As another example, the network device/node may include one or more memories storing instructions for implementing various components described herein, one or more hardware processors configured to execute the instructions stored in the one or more memories, and various data repositories in the one or more memories for storing data structures utilized and manipulated by the various components.

As illustrated in FIG. 1, the network device/node may include a traffic manager operating with other packet processing components and/or resources in the network device/node to process and forward CT and SAF traffic.

In response to receiving an input packet—for forwarding to a next hop toward a destination (address)—or a data unit or a cell in a group of cells constituting the packet, the traffic manager may generate or access input packet control data or packet metadata of the input packet, for example based at least in part on packet data fields of the input packet.

The traffic manager or a processing component operating with the traffic manager then determines whether the input packet is eligible as a CT packet.

Common or shared processing components of the CT path and the SAF path may include a (common and shared) egress port, a (common or shared) packet data buffer for a (common or shared) egress port, a (common and shared) buffering logic or manager, a (common and shared) scheduler, a (common and shared) path merger, etc. These processing components may be used to operate different (path-specific) queues and FIFOs, different (path-specific) scheduling algorithms for different (path specific) packet intaking, enqueuing, dequeuing, etc., as follows.

In response to determining that the input packet is eligible as a CT packet, the traffic manager directs the input packet control data of the CT packet (or CT packet control data for simplicity) to a dedicated CT packet control data path. On the other hand, in response to determining that the input packet is ineligible as a CT packet but rather an SAF packet, the traffic manager directs the input packet control data of the SAF packet (or SAF packet control data for simplicity) to a dedicated SAF packet control data path.

If the input packet is determined as a CT packet, the CT packet control data path for the CT packet may include performing enqueuing and dequeuing operations of the CT packet. The CT packet enqueuing operations may generate data write request(s) to request buffer allocation logic (or a buffer manager) to buffer some or all input data of the CT packet in a data buffer shared by CT and SAF traffic through a corresponding egress port.

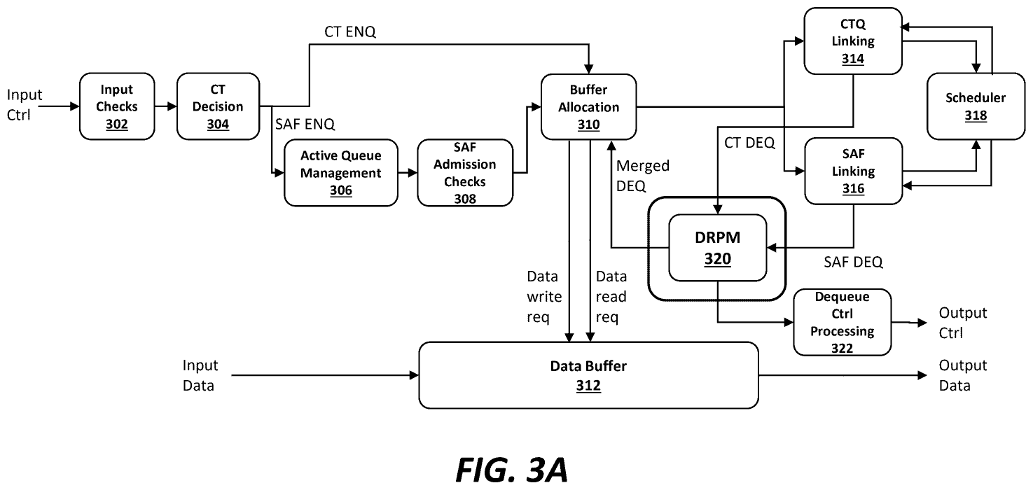

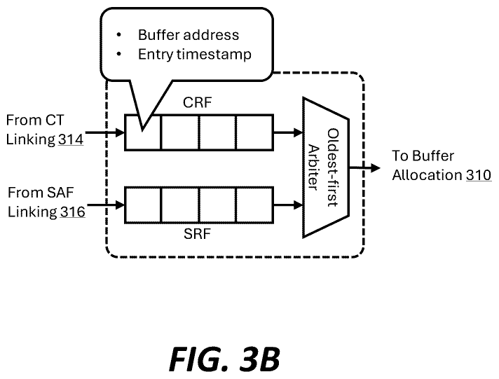

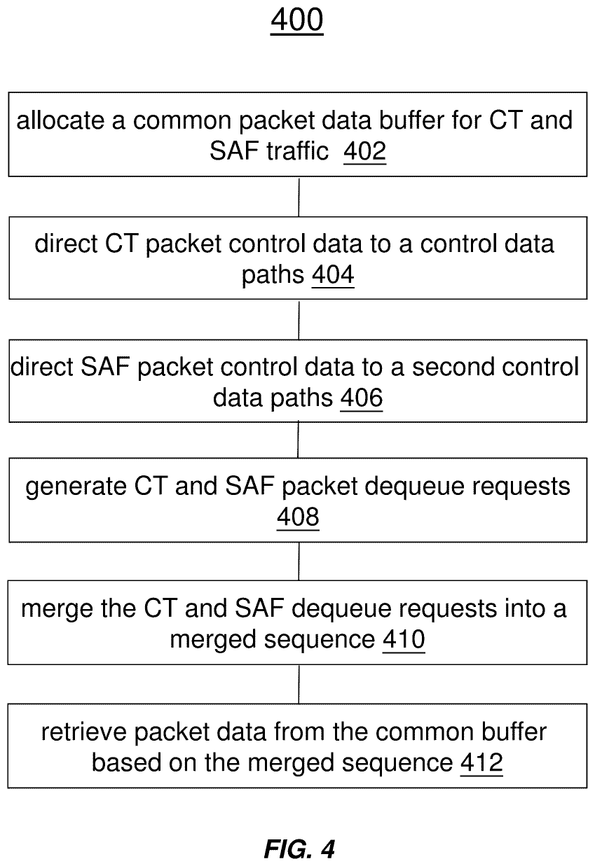

If the input packet is determined as an SAF packet, the SAF packet control data path for the SAF packet may include performing enqueuing and dequeuing operations of the SAF packet as well as SAF-specific or SAF-only operations (not shown in FIG. 1; see e.g. FIG. 2B and FIG. 3A). The SAF packet enqueuing operations may generate data write request(s) to request buffer allocation logic (or a buffer manager) to buffer some or all input data of the SAF packet in the data buffer shared by the CT and SAF traffic through the corresponding egress port. The SAF-specific or SAF-only operations are not performed with a CT packet on the CT packet control data path and are specific or only performed on the SAF packet control data path.

The traffic manager may include or operate with a scheduler for the egress port to manage how packets are processed and forwarded when multiple input packets are waiting to be transmitted through the egress port.

In some operational scenarios, a single CT queue may be set up by the traffic manager or the scheduler to schedule dequeuing of input CT packets for downstream processing including but not limited to packet transmission operations. In comparison, multiple SAF queues may be set up by the traffic manager or the scheduler to schedule dequeuing of input SAF packets for downstream processing.

The input packet control data or the corresponding queuing/linking data or a reference pointer may be enqueued into different (e.g., CT or SAF, different QOS SAF, different priority SAF, different traffic class/type SAF, etc.) queues set up by the traffic manager or the scheduler. The packet control data or queuing/linking data may include or correspond to a path-specific template. An example path-specific template may be a set of path-specific packet related or packet-specific data structures and/or path-specific data field values, for example maintained in inter-packet, inter-cell linked lists, intra-packet linked lists, etc.

The scheduler implements CT dequeuing algorithms such as a first-come-first-serve dequeuing algorithm to dequeue an (e.g., queue head, etc.) element or generate a CT packet dequeue request from the CT queue for a clock cycle. Additionally, optionally or alternatively, the scheduler may implement an optimistic scheduling algorithm to dequeue any (e.g., queue head, etc.) element present in the CT queue without waiting.

The scheduler implements SAF dequeuing algorithms such as one or more of: a first-come first-served (FCFS) algorithm with which SAF packets are forwarded in the order they arrive in SAF queue(s); a weighted round robin (WRR) with which each of some or all of the SAF queues is assigned a fixed time slot in rotation, but SAF queue(s) with higher priority can be assigned larger time slots; priority scheduling with which packets in higher-priority SAF queue(s) are always processed before lower-priority SAF queue(s), potentially preempting them; deficit round robin (DRR) with which fairness is ensured among some or all of the SAF queues while still maintaining prioritization for time-sensitive traffic; and so on.

To arbitrate or allocate shared resources such as bandwidth of the same egress port and/or read access to the same data buffer of the egress between CT and SAF traffic and minimize inter-cell jitters, CT and SAF packet dequeue requests from the CT and SAF packet control data paths (or passageways) are to be merged with or at a dequeue request (path) merger or DRPM. As used herein, some or all packet scheduling operations such as CT or SAF packet scheduling performed by a traffic manager or a scheduler and/or a DRPM therein may refer to (packet-based or cell-based) scheduling operations with respect to one or more subdivision data units in a packet such as scheduling an individual cell or a group of individual cells in a CT or SAF packet. Additionally, optionally or alternatively, in addition to scheduling operations, other operations such as buffer storage operations, buffer retrieval operations, queuing operations, dequeuing operations, merging operations, etc., may also be performed on a packet or cell basis.

To support relatively low latency arbitration (e.g., one to three clock cycle latencies, etc.), the merger may set up, maintain or use a store-and-forward request (SRF) FIFO and a cut-through request (CRF) FIFO—which may be specifically or respectively sized for the CT and SAF traffic. The merger may be implemented with relatively simple arbitration logic to select the oldest among or between (e.g., current, upcoming, etc.) SRF and CRF heads from the SRF and CRF FIFOs, respectively.

While the same or common scheduler and merger are used for both CT and SAF packet control data path (e.g., along with the buffer allocation logic and data buffer, etc.), the CT packet control path—which is an abbreviated path as compared with the (full) SAF packet control data path—incurs lower latency from the scheduler to DRPM. This is due at least in part to the use of relatively simple CT linking structures as compared with SAF linking structures. In addition, the relatively low (CT control path) latency is due to SAF-specific or SAF-only operations being excluded from being performed on the CT packet control data path.

In some operational scenarios, (e.g., at most, etc.) one CT packet dequeue request from the CT queue maintained by the scheduler may arrive or occur to a CT-specific FIFO maintained by the merger (DRPM) per clock cycle. Additionally, optionally or alternatively, at most one SAF packet dequeue request from some or all of the SAF queue maintained by the scheduler may arrive or occur to an SAF-specific FIFO maintained by the DRPM per clock cycle. As used herein, the term “merger” or “DRPM” may refer to a processing component which may be implemented as (e.g., hardware, etc.) logic as well. The DRPM may maintain a CRF FIFO and an SRF FIFO each specifically and respectively sized or optimized to absorb intermittent bursts due at least in part to differences between SAF and CT packet control data path latencies. The scheduler assigns a (DRPM) arrival timestamp to each CT or SAF packet dequeue request that arrives or occurs to the DRPM for entering at the tail (end) of the CT or SAF FIFO.

The DRPM may implement an oldest-first arbiter—which may be prioritized either in favor of SAF or CT in case of a simultaneous arrival of both SAF and CT dequeue requests at their respective FIFOs maintained by the DRPM—to control departures from the CRF and SRF FIFOs maintained by the DRPM. DRPM arrival timestamps of CRF and SRF heads of the SRF and SRF FIFOs are compared in the dequeue request merging operation.

If both CRF and SRF heads are present in the CRF and SRF FIFOs, the oldest head among the CRF and SRF heads as indicated by the respective DRPM arrival timestamps is dequeued or selected by the DRPM in a common or merged sequence of packet dequeue requests sent or provided by the DRPM to the buffer allocation logic.

If only one of the CRF and SRF FIFO has data or entry, its head is dequeued and included in the common sequence of packet dequeue requests.

As a result, the DRPM enforces a (e.g., I/O resource, timing control, etc.) constraint with which at most one dequeue request may depart from the DRPM to the buffer allocation per (e.g., read, etc.) clock cycle. In some operational scenarios, dequeue request departure happens if either SRF or CRF FIFO (or both) has data or entries.

The dequeue (request) path merging operations as described herein allows pending CT packets to opportunistically use or take up any bandwidth unused by any SAF packets arriving at the DRPM from the scheduler before the CT packets. At the same time, this allows the pending SAF packets that arrive earlier at the DRPM than some of the CT packets to continue using egress (port) bandwidth with a target/intended/optimized bandwidth distribution (e.g., no or minimal impact from the CT traffic depending on the amount/volume of the CT traffic, no or minimal inter-cell jitters which might otherwise be caused by racing CT packets ahead of earlier arriving SAF packets out of the egress port, etc.) for the SAF traffic in accordance with scheduling/dequeuing algorithms implemented by the scheduler and/or the DRPM.

After a dequeue request corresponding to the CRF or SRF head (entry) in the CRF or SRF FIFO depart from, or is dispatched by, the DRPM to the buffer allocation logic or buffer manager, the CT and SAF packet data control paths merge into the same or common packet control path or sub-path in which same or common packet processing operations—generating output packet control data, fetching input packet data with data read request(s), generating output packet data, forwarding an output network/data packet corresponding to the input network/data packet, etc.—may be performed.

In some operational scenarios, for a given (e.g., CT, SAF, etc.) packet or a cell thereof, only a single data write request is incurred to the data buffer when the packet or the cell is received by an ingress processor and only a single read request is incurred to the same data buffer when the packet or the cell is to be transmitted or forwarded from the egress port.

### 3.0. Packet Communication Network

FIG. 2A illustrates example aspects of an example networking system 100, also referred to as a network, in which the techniques described herein may be practiced, according to an embodiment. Networking system 100 comprises a plurality of interconnected nodes 110a-110n (collectively nodes 110), each implemented by a different computing device. For example, a node 110 may be a single networking computing device (or a network device), such as a router or switch, in which some or all of the processing components described herein are implemented in application-specific integrated circuits (ASICs), field programmable gate arrays (FPGAs), or other integrated circuit(s). As another example, a node 110 may include one or more memories (e.g., non-transitory computer-readable media, etc.) storing instructions for implementing various components described herein, one or more hardware processors configured to execute the instructions stored in the one or more memories, and various data repositories in the one or more memories for storing data structures utilized and manipulated by the various components.

Each node 110 is connected to one or more other nodes 110 in network 100 by one or more communication links, depicted as lines between nodes 110. The communication links may be any suitable wired cabling or wireless links. Note that system 100 illustrates only one of many possible arrangements of nodes within a network. Other networks may include fewer or additional nodes 110 having any number of links between them.

While each node 110 may or may not have a variety of other functions, in an embodiment, each node 110 is configured to send, receive, and/or relay data to one or more other nodes 110 via these links. In general, data is communicated as series of discrete units or structures of data represented by signals transmitted over the communication links. As illustrated in FIG. 2A, some or all of the nodes including, but not necessarily limited to only, node 100c may implement some or all template-based CT/SAF path selection techniques as described herein.

### 3.1. Packets and Other Data Units

Different nodes 110 within a network 100 may send, receive, and/or relay data units at different communication levels, or layers. For instance, a first node 110 may send a data unit at the network layer (e.g., a TCP segment, IP packet, etc.) to a second node 110 over a path that includes an intermediate node 110. This data unit will be broken into smaller data units at various sublevels before it is transmitted from the first node 110. These smaller data units may be referred to as “subunits” or “portions” of the larger data unit.

For example, the data unit may be sent in one or more of: packets, cells, collections of signal-encoded bits, etc., to the intermediate node 110. Depending on the network type and/or the device type of the intermediate node 110, the intermediate node 110 may rebuild the entire original data unit before routing the information to the second node 110, or the intermediate node 110 may simply rebuild certain subunits of the data (e.g., frames and/or cells) and route those subunits to the second node 110 without ever composing the entire original data unit.

When a node 110 receives a data unit, it typically examines addressing information within the data unit (and/or other information within the data unit) to determine how to process the data unit. The addressing information may be, for instance, an Internet Protocol (IP) address, MPLS label, or any other suitable information. If the addressing information indicates that the receiving node 110 is not the destination for the data unit, the receiving node 110 may look up the destination node 110 within receiving node's routing information and route the data unit to another node 110 connected to the receiving node 110 based on forwarding instructions associated with the destination node 110 (or an address group to which the destination node belongs). The forwarding instructions may indicate, for instance, an outgoing port over which to send the data unit, a label to attach the data unit, a next hop, etc. In cases where multiple (e.g., equal-cost, non-equal-cost, etc.) paths to the destination node 110 are possible, the forwarding instructions may include information indicating a suitable approach for selecting one of those paths, or a path deemed to be the best path may already be defined.

Addressing information, flags, labels, and other metadata used for determining how to handle a data unit are typically embedded within a portion of the data unit known as the header. The header typically is located at the beginning of the data unit, and is followed by the payload of the data unit, which is the information actually being sent in the data unit. A header typically is comprised of fields of different types, such as a destination address field, source address field, destination port field, source port field, and so forth. In some protocols, the number and the arrangement of fields may be fixed. Other protocols allow for arbitrary numbers of fields, with some or all of the fields being preceded by type information that explains to a node the meaning of the field.

A traffic flow is a sequence of data units, such as packets, with common attributes, typically being from a same source to a same destination. In an embodiment, the source of the traffic flow may mark each data unit in the sequence as a member of the flow using a label, tag, or other suitable identifier within the data unit. In another embodiment, the flow is identified by deriving an identifier from other fields in the data unit (e.g., a “five-tuple” or “5-tupple” combination of a source address, source port, destination address, destination port, and protocol). A flow is often intended to be sent in sequence, and network devices may therefore be configured to send all data units within a given flow along a same path to ensure that the flow is received in sequence.

Data units may be single-destination or multi-destination. Single-destination data units are typically unicast data units, specifying only a single destination address. Multi-destination data units are often multicast data units, specifying multiple destination addresses, or addresses shared by multiple destinations. However, a given node may in some circumstances treat unicast data units as having multiple destinations. For example, the node may be configured to mirror a data unit to another port such as a law enforcement port or debug port, copy the data unit to a central processing unit for diagnostic purposes or suspicious activity, recirculate a data unit, or take other actions that cause a unicast data unit to be sent to multiple destinations. By the same token, a given data unit may in some circumstances treat a multicast data unit as a single-destination data unit, if, for example all destinations targeted by the data unit are reachable by the same egress port.

For convenience, many of the techniques described in this disclosure are described with respect to routing data units that are IP packets in an L3 (level/layer 3) network, or routing the constituent cells and frames thereof in an L2 (level/layer 2) network, in which contexts the described techniques have particular advantages. It is noted, however, that these techniques may also be applied to realize advantages in routing other types of data units conforming to other protocols and/or at other communication layers within a network. Thus, unless otherwise stated or apparent, the techniques described herein should also be understood to apply to contexts in which the “data units” are of any other type of data structure communicated across a network, such as segments or datagrams. That is, in these contexts, other types of data structures may be used in place of packets, cells, frames, and so forth.

It is noted that the actual physical representation of a data unit may change as a result of the processes described herein. For instance, a data unit may be converted from a physical representation at a particular location in one memory to a signal-based representation, and back to a physical representation at a different location in a potentially different memory, as it is moved from one component to another within a network device or even between network devices. Such movement may technically involve deleting, converting, and/or copying some or all of the data unit any number of times. For simplification, however, the data unit is logically said to remain the same data unit as it moves through the device, even if the physical representation of the data unit changes. Similarly, the contents and/or structure of a data unit may change as it is processed, such as by adding or deleting header information, adjusting cell boundaries, or even modifying payload data. A modified data unit is nonetheless still said to be the same data unit, even after altering its contents and/or structure.

### 3.2. Network Paths

Any node in the depicted network 100 may communicate with any other node in the network 100 by sending data units through a series of nodes 110 and links, referred to as a path. For example, Node B (110b) may send data units to Node H (110h) via a path from Node B to Node D to Node E to Node H. There may be a large number of valid paths between two nodes. For example, another path from Node B to Node H is from Node B to Node D to Node G to Node H.

In an embodiment, a node 110 does not actually need to specify a full path for a data unit that it sends. Rather, the node 110 may simply be configured to calculate the best path for the data unit out of the device (e.g., which egress port it should send the data unit out on, etc.). When a node 110 receives a data unit that is not addressed directly to the node 110, based on header information associated with a data unit, such as path and/or destination information, the node 110 relays the data unit along to either the destination node 110, or a “next hop” node 110 that the node 110 calculates is in a better position to relay the data unit to the destination node 110. In this manner, the actual path of a data unit is product of each node 110 along the path making routing decisions about how best to move the data unit along to the destination node 110 identified by the data unit.

### 4.0. Network Device

FIG. 2B illustrates example aspects of an example network device 200 in which techniques described herein may be practiced, according to an embodiment. Network device 200 is a computing device comprising any combination of hardware and software configured to implement the various logical components described herein, including components 210-290. For example, the apparatus may be a single networking computing device, such as a router or switch, in which some or all of the components 210-290 described herein are implemented using application-specific integrated circuits (ASICs). As another example, an implementing apparatus may include one or more memories storing instructions for implementing various components described herein, one or more hardware processors configured to execute the instructions stored in the one or more memories, and various data repositories in the one or more memories for storing data structures utilized and manipulated by various components 210-290.

Device 200 is generally configured to receive and forward data units 205 to other devices in a network, such as network 100, by means of a series of operations performed at various components within the device 200. Note that, in an embodiment, some or all of the nodes 110 in system 100 may each be or include a separate network device 200. In an embodiment, a node 110 may include more than one device 200. In an embodiment, device 200 may itself be one of a number of components within a node 110. For instance, network device 200 may be an integrated circuit, or “chip,” dedicated to performing switching and/or routing functions within a network switch or router. The network switch or router further comprises one or more central processor units, storage units, memories, physical interfaces, LED displays, or other components external to the chip, some or all of which may communicate with the chip, in an embodiment.

A non-limiting example flow of a data unit 205 through various subcomponents of the forwarding logic of device 200 is as follows. After being received via a port 210, a data unit 205 may be buffered in an ingress buffer 224 and queued in an ingress queue 225 by an ingress arbiter 220 until the data unit 205 can be processed by an ingress packet processor 230, and then delivered to an interconnect (or a cross connect) such as a switching fabric. From the interconnect, the data unit 205 may be forwarded to a traffic manager 240. The traffic manager 240 may store the data unit 205 in an egress buffer 244 and assign the data unit 205 to an egress queue 245. The traffic manager 240 manages the flow of the data unit 205 through the egress queue 245 until the data unit 205 is released to an egress packet processor 250. Depending on the processing, the traffic manager 240 may then assign the data unit 205 to another queue so that it may be processed by yet another egress processor 250, or the egress packet processor 250 may send the data unit 205 to an egress arbiter 260 which temporally stores or buffers the data unit 205 in a transmit buffer and finally forwards out the data unit via another port 290. Of course, depending on the embodiment, the forwarding logic may omit some of these subcomponents and/or include other subcomponents in varying arrangements.

Example components of a device 200 are now described in further detail.

### 4.1. Port

Network device 200 includes ports 210/290. Ports 210, including ports 210-1 through 210-N, are inbound (“ingress”) ports by which data units referred to herein as data units 205 are received over a network, such as network 110. Ports 290, including ports 290-1 through 290-N, are outbound (“egress”) ports by which at least some of the data units 205 are sent out to other destinations within the network, after having been processed by the network device 200.

Egress ports 290 may operate with corresponding transmit buffers to store data units or subunits (e.g., packets, cells, frames, transmission units, etc.) divided therefrom that are to be transmitted through ports 290. Transmit buffers may have one-to-one correspondence relationships with ports 290, many-to-one correspondence with ports 290, and so on. Egress processors 250 or egress arbiters 260 operating with egress processors 250 may output these data units or subunits to transmit buffers before these units/subunits are transmitted out from ports 290.

Data units 205 may be of any suitable PDU type, such as packets, cells, frames, transmission units, etc. In an embodiment, data units 205 are packets. However, the individual atomic data units upon which the depicted components may operate may actually be subunits of the data units 205. For example, data units 205 may be received, acted upon, and transmitted at a cell or frame level. These cells or frames may be logically linked together as the data units 205 (e.g., packets, etc.) to which they respectively belong for purposes of determining how to handle the cells or frames. However, the subunits may not actually be assembled into data units 205 within device 200, particularly if the subunits are being forwarded to another destination through device 200.

Ports 210/290 are depicted as separate ports for illustrative purposes, but may actually correspond to the same physical hardware ports (e.g., network jacks or interfaces, etc.) on the network device 210. That is, a network device 200 may both receive data units 205 and send data units 205 over a single physical port, and the single physical port may thus function as both an ingress port 210 (e.g., one of 210a, 210b, 210c, . . . 210n, etc.) and egress port 290. Nonetheless, for various functional purposes, certain logic of the network device 200 may view a single physical port as a separate ingress port 210 and a separate egress port 290. Moreover, for various functional purposes, certain logic of the network device 200 may subdivide a single physical ingress port or egress port into multiple ingress ports 210 or egress ports 290, or aggregate multiple physical ingress ports or egress ports into a single ingress port 210 or egress port 290. Hence, in some operational scenarios, ports 210 and 290 should be understood as distinct logical constructs that are mapped to physical ports rather than simply as distinct physical constructs.

In some embodiments, the ports 210/290 of a device 200 may be coupled to one or more transceivers, such as Serializer/Deserializer (“SerDes”) blocks. For instance, ports 210 may provide parallel inputs of received data units into a SerDes block, which then outputs the data units serially into an ingress packet processor 230. On the other end, an egress packet processor 250 may input data units serially into another SerDes block, which outputs the data units in parallel to ports 290.

### 4.2. Packet Processors

A device 200 comprises one or more packet processing components that collectively implement forwarding logic by which the device 200 is configured to determine how to handle each data unit 205 that is received at device 200. These packet processors components may be any suitable combination of fixed circuitry and/or software-based logic, such as specific logic components implemented by one or more Field Programmable Gate Arrays (FPGAs) or Application-Specific Integrated Circuits (ASICs), or a general-purpose processor executing software instructions.

Different packet processors 230 and 250 may be configured to perform different packet processing tasks. These tasks may include, for example, identifying paths along which to forward data units 205, forwarding data units 205 to egress ports 290, implementing flow control and/or other policies, manipulating packets, performing statistical or debugging operations, and so forth. A device 200 may comprise any number of packet processors 230 and 250 configured to perform any number of processing tasks.

In an embodiment, the packet processors 230 and 250 within a device 200 may be arranged such that the output of one packet processor 230 or 250 may, eventually, be inputted into another packet processor 230 or 250, in such a manner as to pass data units 205 from certain packet processor(s) 230 and/or 250 to other packet processor(s) 230 and/or 250 in a sequence of stages, until finally disposing of the data units 205 (e.g., by sending the data units 205 out an egress port 290, “dropping” the data units 205, etc.). The exact set and/or sequence of packet processors 230 and/or 250 that process a given data unit 205 may vary, in some embodiments, depending on the attributes of the data unit 205 and/or the state of the device 200. There is no limit to the number of packet processors 230 and/or 250 that may be chained together in such a manner.

Based on decisions made while processing a data unit 205, a packet processor 230 or 250 may, in some embodiments, and/or for certain processing tasks, manipulate a data unit 205 directly. For instance, the packet processor 230 or 250 may add, delete, or modify information in a data unit header or payload. In other embodiments, and/or for other processing tasks, a packet processor 230 or 250 may generate control information that accompanies the data unit 205, or is merged with the data unit 205, as the data unit 205 continues through the device 200. This control information may then be utilized by other components of the device 200 to implement decisions made by the packet processor 230 or 250. In some operational scenarios, the data unit that is actually processed through a processing pipeline—while the original payload and header are stored in memory—may be referred to as a descriptor (or a template).

In an embodiment, a packet processor 230 or 250 need not necessarily process an entire data unit 205, but may rather only receive and process a subunit of a data unit 205 comprising header information for the data unit. For instance, if the data unit 205 is a packet comprising multiple cells, the first cell, or a first subset of cells, might be forwarded to a packet processor 230 or 250, while the remaining cells of the packet (and potentially the first cell(s) as well) are forwarded in parallel to a merger component where they await results of the processing.

In an embodiment, a packet processor may be generally classified as an ingress packet processor 230 or an egress packet processor 250. Generally, an ingress processor 230 resolves destinations for a traffic manager 240 to determine which egress ports 290 (e.g., one of 290a, 290b, 290c, . . . 290n, etc.) and/or queues a data unit 205 should depart from. There may be any number of ingress processors 230, including just a single ingress processor 230.

In an embodiment, an ingress processor 230 performs certain intake tasks on data units 205 as they arrive. These intake tasks may include, for instance, and without limitation, parsing data units 205, performing routing related lookup operations, categorically blocking data units 205 with certain attributes and/or when the device 200 is in a certain state, duplicating certain types of data units 205, making initial categorizations of data units 205, and so forth. Once the appropriate intake task(s) have been performed, the data units 205 are forwarded to an appropriate traffic manager 240, to which the ingress processor 230 may be coupled directly or via various other components, such as an interconnect component.

The egress packet processor(s) 250 of a device 200, by contrast, may be configured to perform non-intake tasks necessary to implement the forwarding logic of the device 200. These tasks may include, for example, tasks such as identifying paths along which to forward the data units 205, implementing flow control and/or other policies, manipulating data units, performing statistical or debugging operations, and so forth. In an embodiment, there may be different egress packet processors(s) 250 assigned to different flows or other categories of traffic, such that not all data units 205 will be processed by the same egress packet processor 250.

In an embodiment, each egress processor 250 is coupled to a different group of egress ports 290 to which they may send data units 205 processed by the egress processor 250. In an embodiment, access to a group of ports 290 or corresponding transmit buffers for the ports 290 may be regulated via an egress arbiter 260 coupled to the egress packet processor 250. In some embodiments, an egress processor 250 may also or instead be coupled to other potential destinations, such as an internal central processing unit, a storage subsystem, or a traffic manager 240.

### 4.3. Buffers

Since not all data units 205 received by the device 200 can be processed by component(s) such as the packet processor(s) 230 and/or 250 and/or ports 290 at the same time, various components of device 200 may temporarily store data units 205 in memory structures referred to as (e.g., ingress, egress, etc.) buffers while the data units 205 are waiting to be processed. For example, a certain packet processor 230 or 250 or port 290 may only be capable of processing a certain amount of data such as a certain number of data units 205, or portions of data units 205, in a given clock cycle, meaning that other data units 205, or portions of data units 205, destined for the packet processor 230 or 250 or port 290 must either be ignored (e.g., dropped, etc.) or stored. At any given time, a large number of data units 205 may be stored in the buffers of the device 200, depending on network traffic conditions.

A device 200 may include a variety of buffers, each utilized for varying purposes and/or components. Generally, a data unit 205 awaiting processing by a component is held in a buffer associated with that component until the data unit 205 is “released” to the component for processing.

Buffers may be implemented using any number of distinct banks of memory. Each bank may be a portion of any type of memory, including volatile memory and/or non-volatile memory. In an embodiment, each bank comprises many addressable “entries” (e.g., rows, columns, etc.) in which data units 205, subunits, linking data, or other types of data, may be stored. The size of each entry in a given bank is known as the “width” of the bank, while the number of entries in the bank is known as the “depth” of the bank. The number of banks may vary depending on the embodiment.

Each bank may have associated access limitations. For instance, a bank may be implemented using single-ported memories that may only be accessed once in a given time slot (e.g., clock cycle, etc.). Hence, the device 200 may be configured to ensure that no more than one entry need be read from or written to the bank in a given time slot. A bank may instead be implemented in a multi-ported memory to support two or more accesses in a given time slot. However, single-ported memories may be desirable in many cases for higher operating frequencies and/or reducing costs.

In an embodiment, in addition to buffer banks, a device may be configured to aggregate certain banks together into logical banks that support additional reads or writes in a time slot and/or higher write bandwidth. In an embodiment, each bank, whether logical or physical or of another (e.g., addressable, hierarchical, multi-level, sub bank, etc.) organization structure, is capable of being accessed concurrently with each other bank in a same clock cycle, though full realization of this capability is not necessary.

Some or all of the components in device 200 that utilize one or more buffers may include a buffer manager configured to manage use of those buffer(s). Among other processing tasks, the buffer manager may, for example, maintain a mapping of data units 205 to buffer entries in which data for those data units 205 is stored, determine when a data unit 205 must be dropped because it cannot be stored in a buffer, perform garbage collection on buffer entries for data units 205 (or portions thereof) that are no longer needed, and so forth.

A buffer manager may include buffer assignment logic. The buffer assignment logic is configured to identify which buffer entry or entries should be utilized to store a given data unit 205, or portion thereof. In some embodiments, each data unit 205 is stored in a single entry. In yet other embodiments, a data unit 205 is received as, or divided into, constituent data unit portions for storage purposes. The buffers may store these constituent portions separately (e.g., not at the same address location or even within the same bank, etc.). The one or more buffer entries in which a data unit 205 are stored are marked as utilized (e.g., in a “free” list, free or available if not marked as utilized, etc.) to prevent newly received data units 205 from overwriting data units 205 that are already buffered. After a data unit 205 is released from the buffer, the one or more entries in which the data unit 205 is buffered may then be marked as available for storing new data units 205.

In some embodiments, the buffer assignment logic is relatively simple, in that data units 205 or data unit portions are assigned to banks and/or specific entries within those banks randomly or using a round-robin approach. In some embodiments, data units 205 are assigned to buffers at least partially based on characteristics of those data units 205, such as corresponding traffic flows, destination addresses, source addresses, ingress ports, and/or other metadata. For example, different banks may be utilized to store data units 205 received from different ports 210 or sets of ports 210. In an embodiment, the buffer assignment logic also or instead utilizes buffer state information, such as utilization metrics, to determine which bank and/or buffer entry to assign to a data unit 205, or portion thereof. Other assignment considerations may include buffer assignment rules (e.g., no writing two consecutive cells from the same packet to the same bank, etc.) and I/O scheduling conflicts, for example, to avoid assigning a data unit to a bank when there are no available write operations to that bank on account of other components reading content already in the bank.

### 4.4. Queues

In an embodiment, to manage the order in which data units 205 are processed from the buffers, various components of a device 200 may implement queueing logic. For example, the flow of data units through ingress buffers 224 may be managed using ingress queues 225 while the flow of data units through egress buffers 244 may be managed using egress queues 245.

Each data unit 205, or the buffer locations(s) in which the data unit 205 is stored, is said to belong to one or more constructs referred to as queues. Typically, a queue is a set of memory locations (e.g., in the buffers 224 and/or 244, etc.) arranged in some order by metadata describing the queue. The memory locations may (and often are) non-contiguous relative to their addressing scheme and/or physical or logical arrangement. For example, the metadata for one queue may indicate that the queue is comprised of, in order, entry addresses 2, 50, 3, and 82 in a certain buffer.

In various embodiments, the sequence in which the queue arranges its constituent data units 205 generally corresponds to the order in which the data units 205 or data unit portions in the queue will be released and processed. Such queues are known as first-in-first-out (“FIFO”) queues, though in other embodiments other types of queues may be utilized. In some embodiments, the number of data units 205 or data unit portions assigned to a given queue at a given time may be limited, either globally or on a per-queue basis, and this limit may change over time.

### 4.5. Traffic Manager

According to an embodiment, a device 200 further includes one or more traffic managers 240 configured to control the flow of data units to one or more packet processor(s) 230 and/or 250. For instance, a buffer manager (or buffer allocation logic) within the traffic manager 240 may temporarily store data units 205 in buffers 244 as they await processing by egress processor(s) 250. A traffic manager 240 may receive data units 205 directly from a port 210, from an ingress processor 230, and/or other suitable components of device 200. In an embodiment, the traffic manager 240 receives one TDU from each possible source (e.g. each port 210, etc.) each clock cycle or other time slot.

Traffic manager 240 may include or be coupled to egress buffers 244 for buffering data units 205 prior to sending those data units 205 to their respective egress processor(s) 250. A buffer manager within the traffic manager 240 may temporarily store data units 205 in egress buffers 244 as they await processing by egress processor(s) 250. The number of egress buffers 244 may vary depending on the embodiment. A data unit 205 or data unit portion in an egress buffer 244 may eventually be “released” to one or more egress processor(s) 250 for processing, by reading the data unit 205 from the (e.g., egress, etc.) buffer 244 and sending the data unit 205 to the egress processor(s) 250. In an embodiment, traffic manager 240 may release up to a certain number of data units 205 from buffers 244 to egress processors 250 each clock cycle or other defined time slot.

Beyond managing the use of buffers 244 to store data units 205 (or copies thereof), a traffic manager 240 may include queue management logic configured to assign buffer entries to queues and manage the flow of data units 205 through the queues. The traffic manager 240 may, for instance, identify a specific queue to assign a data unit 205 to upon receipt of the data unit 205. The traffic manager 240 may further determine when to release—also referred to as “dequeuing”—data units 205 (or portions thereof) from queues and provide those data units 205 to specific packet processor(s) 250. Buffer management logic in the traffic manager 240 may further “deallocate” entries in a buffer 244 that store data units 205 are no longer linked to the traffic manager's queues. These entries are then reclaimed for use in storing new data through a garbage collection process.

In an embodiment, different queues may exist for different destinations. For example, each port 210 and/or port 290 may have its own set of queues. The queue to which an incoming data unit 205 is assigned and linked may, for instance, be selected based on forwarding information indicating which port 290 the data unit 205 should depart from. In an embodiment, a different egress processor 250 may be associated with each different set of one or more queues. In an embodiment, the current processing context of the data unit 205 may be used to select which queue a data unit 205 should be assigned to.

In an embodiment, there may also or instead be different queues for different flows or sets of flows. That is, each identifiable traffic flow or group of traffic flows is assigned its own set of queues to which its data units 205 are respectively assigned.

Device 200 may comprise any number (e.g., one or more, etc.) of packet processors 230 and/or 250 and traffic managers 240. For instance, different sets of ports 210 and/or ports 290 may have their own traffic manager 240 and packet processors 230 and/or 250. As another example, in an embodiment, the traffic manager 240 may be duplicated for some or all of the stages of processing a data unit. For example, system 200 may include a traffic manager 240 and egress packet processor 250 for an egress stage performed upon the data unit 205 exiting the system 200, and/or a traffic manager 240 and packet processor 230 or 250 for any number of intermediate stages. The data unit 205 may thus pass through any number of traffic managers 240 and/or packet processors 230 and/or 250 prior to exiting the system 200.

In an embodiment, a traffic manager 240 is coupled to the ingress packet processor(s) 230, such that data units 205 (or portions thereof) are assigned to buffers only upon being initially processed by an ingress packet processor 230. Once in an egress buffer 244, a data unit 205 (or portion thereof) may be “released” to one or more egress packet processor(s) 250 for processing, either by the traffic manager 240 sending a link or other suitable addressing information for the corresponding buffer 244 to the egress packet processor 250, or by sending the data unit 205 directly.

In the course of processing a data unit 205, a device 200 may replicate a data unit 205 one or more times for purposes such as, without limitation, multicasting, mirroring, debugging, and so forth. For example, a single data unit 205 may be replicated to multiple egress queues 245. Any given copy of the data unit may be treated as a received packet to be routed or forwarded with a multi-path group under techniques as described herein. For instance, a data unit 205 may be linked to separate queues for each of ports 1, 3, and 5. As another example, a data unit 205 may be replicated a number of times after it reaches the head of a queue (e.g., for different egress processors 250, etc.). Hence, though certain techniques described herein may refer to the original data unit 205 that was received by the device 200, it is noted that those techniques will equally apply to copies of the data unit 205 that have been generated for various purposes. A copy of a data unit 205 may be partial or complete. Moreover, there may be an actual copy of the data unit 205 in buffers, or a single copy of the data unit 205 may be linked from a single buffer location to multiple queues at the same time.

The traffic manager may implement a dedicated CT packet control data path—for CT traffic—that is separate from an SAF packet control data path for SAF traffic. The SAF packet control data path may include SAF-specific or SAF-only packet processing operations—performed with an SAF packet—that are not performed with a CT packet.

To coordinate the use and access of common resources for the CT and SAF traffic such as a common data buffer used for both CT and SAF traffic through a corresponding egress port, the traffic manager may enhance or implement a scheduler that maintain separate queues for the CT and SAF traffic and a dequeue request (path) merger or DRPM that merges CT and SAF packet dequeue requests for transmission out of the egress port into a common sequence of packet dequeue request.

The common sequence of dequeue requests (denoted as “Merged Dequeue Request(s)” in FIG. 2B) for both the CT and SAF traffic may include a single dequeue request per (read) clock cycle that can be used to retrieve incoming CT or SAF packet data stored in the common data buffer for the egress port. The retrieved CT or SAF packet data may be transformed or used to generate outgoing packet data to be included in a corresponding outgoing packet to be transmitted or forwarded through the egress port.

### 4.6. Forwarding Logic

The logic by which a device 200 determines how to handle a data unit 205—such as where and whether to send a data unit 205, whether to perform additional processing on a data unit 205, etc.—is referred to as the forwarding logic of the device 200. This forwarding logic is collectively implemented by a variety of the components of the device 200, such as described above. For example, an ingress packet processor 230 may be responsible for resolving the destination of a data unit 205 and determining the set of actions/edits to perform on the data unit 205, and an egress packet processor 250 may perform the edits. Or, the egress packet processor 250 may also determine actions and resolve a destination in some cases. Also, there may be embodiments when the ingress packet processor 230 performs edits as well.

The forwarding logic may be hard-coded and/or configurable, depending on the embodiment. For example, the forwarding logic of a device 200, or portions thereof, may, in some instances, be at least partially hard-coded into one or more ingress processors 230 and/or egress processors 250. As another example, the forwarding logic, or elements thereof, may also be configurable, in that the logic changes over time in response to analyses of state information collected from, or instructions received from, the various components of the device 200 and/or other nodes in the network in which the device 200 is located.

In an embodiment, a device 200 will typically store in its memories one or more forwarding tables (or equivalent structures) that map certain data unit attributes or characteristics to actions to be taken with respect to data units 205 having those attributes or characteristics, such as sending a data unit 205 to a selected path, or processing the data unit 205 using a specified internal component. For instance, such attributes or characteristics may include a Quality-of-Service level specified by the data unit 205 or associated with another characteristic of the data unit 205, a flow control group, an ingress port 210 through which the data unit 205 was received, a tag or label in a packet's header, a source address, a destination address, a packet type, or any other suitable distinguishing property. A traffic manager 240 may, for example, implement logic that reads such a table, determines one or more ports 290 to send a data unit 205 to based on the table, and sends the data unit 205 to an egress processor 250 that is coupled to the one or more ports 290.

According to an embodiment, the forwarding tables describe groups of one or more addresses, such as subnets of IPv4 or IPv6 addresses. Each address is an address of a network device on a network, though a network device may have more than one address. Each group is associated with a potentially different set of one or more actions to execute with respect to data units that resolve to (e.g., are directed to, etc.) an address within the group. Any suitable set of one or more actions may be associated with a group of addresses, including without limitation, forwarding a message to a specified “next hop,” duplicating the message, changing the destination of the message, dropping the message, performing debugging or statistical operations, applying a quality of service policy or flow control policy, and so forth.

For illustrative purposes, these tables are described as “forwarding tables,” though it will be noted that the extent of the action(s) described by the tables may be much greater than simply where to forward the message. For example, in an embodiment, a table may be a basic forwarding table that simply specifies a next hop for each group. In other embodiments, a table may describe one or more complex policies for each group. Moreover, there may be different types of tables for different purposes. For instance, one table may be a basic forwarding table that is compared to the destination address of each packet, while another table may specify policies to apply to packets upon ingress based on their destination (or source) group, and so forth.

In an embodiment, forwarding logic may read port state data for ports 210/290. Port state data may include, for instance, flow control state information describing various traffic flows and associated traffic flow control rules or policies, link status information indicating links that are up or down, port utilization information indicating how ports are being utilized (e.g., utilization percentages, utilization states, etc.). Forwarding logic may be configured to implement the associated rules or policies associated with the flow(s) to which a given packet belongs.

As data units 205 are routed through different nodes in a network, the nodes may, on occasion, discard, fail to send, or fail to receive certain data units 205, thus resulting in the data units 205 failing to reach their intended destination. The act of discarding of a data unit 205, or failing to deliver a data unit 205, is typically referred to as “dropping” the data unit. Instances of dropping a data unit 205, referred to herein as “drops” or “packet loss,” may occur for a variety of reasons, such as resource limitations, errors, or deliberate policies. Different components of a device 200 may make the decision to drop a data unit 205 for various reasons. For instance, a traffic manager 240 may determine to drop a data unit 205 because, among other reasons, buffers are overutilized, a queue is over a certain size, and/or a data unit 205 has a certain characteristic.

### 5.0. CT and SAF Traffic Management

FIG. 3A illustrates example (relatively detailed) operations for processing and forwarding CT traffic and SAF traffic that shares common resources of a network device/node in a communication network as described herein. For example, the network device/node (e.g., 110 of FIG. 2A, etc.) may be a single networking computing device (or a network device), such as a router or switch, in which some or all of the processing components described herein are implemented in application-specific integrated circuits (ASICs), field programmable gate arrays (FPGAs), or other integrated circuit(s). As another example, the network device/node may include one or more memories storing instructions for implementing various components described herein, one or more hardware processors configured to execute the instructions stored in the one or more memories, and various data repositories in the one or more memories for storing data structures utilized and manipulated by the various components.

As illustrated in FIG. 3A, in response to receiving an input network/data packet (or unit) for forwarding to a next hop toward a destination (address), the network device/node or one or more packet processing components such as an ingress (packet) processor, an ingress (packet) arbiter, a traffic manager, etc., may generate input packet control data (which may also be referred to as metadata for packet processing and forwarding) corresponding to the input network/data packet. Some or all of the input packet control data—denoted as “Input Ctrl” in FIG. 3A—may be extracted or derived from one or more packet data fields (e.g., in one or more header portions, one or more payload portions, etc.), etc.

Some or all of the input packet control data of the input packet may be inspected, validated, or checked—denoted as “Input Checks” operations 302 in FIG. 3A such as error detection, checksum or CRC code validation, etc.—to ensure the input packet is a valid packet to be further processed or forwarded by the network device/node.

Based at least in part on the input packet control data and/or results of the input checks, the network device/node then determines—denoted as “CT Decision” 304 in FIG. 3A—whether the input packet is eligible as a cut-through packet, which may be expedited in subsequent packet queuing, dequeuing and forwarding operations.

In response to determining that the input packet is, or is eligible as, a CT packet, the network device/node or the traffic manager therein directs the CT packet to a dedicated CT packet control data path. As used herein, CT packets include actual CT packets as well as any other packet that is eligible to be treated as a CT packet. On the other hand, in response to determining that the input packet is not, or is ineligible as, a CT packet, the network device/node or the traffic manager therein directs the input (or SAF) packet to a dedicated SAF packet control data path.

In scenarios where the input packet is a CT packet, the CT packet control data path for the CT packet may include performing enqueuing and dequeuing operations of the CT packet. The CT packet enqueuing operations—denoted as “CT ENQ” in FIG. 3A—may generate a data write request (or req) to request buffer allocation logic 310 (e.g., a buffer manager, etc.) to buffer some or all received data (denoted as “Input Data” in FIG. 3A) of the input (CT) packet in a (e.g., common to an egress port, etc.) data buffer 312. In addition, (e.g., relatively light-weight, etc.) CT queuing data including but not limited to CT (e.g., intra-packet, inter-packet, etc.) linking data 314 may be generated based at least in part on the input (CT) packet control data and used to enqueue the input (CT) packet in a dedicated CT packet (control data) queue set up for an egress port or for the data buffer allocated for forwarding packets through the egress port on the CT packet control data path.

In scenarios where the input packet is an SAF packet, the SAF packet control data path for the SAF packet may include performing enqueuing and dequeuing operations of the SAF packet as well as (other or additional) SAF-specific or SAF-only operations. These SAF-specific or SAF-only operations are not performed with a CT packet on the CT packet control data path, and are specific or only performed on the SAF packet control data path. For example, the SAF packet enqueuing operations—denoted as “SAF ENQ” in FIG. 3A—may include performing SAF-specific or SAF-only operations such as active queue management 306 and/or SAF admission checks 308. In addition, the SAF packet enqueuing operations may generate a data write request (or req) to request buffer allocation logic 310 to buffer some or all received data (denoted as “Input Data” in FIG. 3A) of the input (SAF) packet in the (e.g., common to an egress port, etc.) data buffer 312. In addition, SAF queuing data including but not limited to SAF (e.g., intra-packet, inter-packet, etc.) linking data 316 may be generated based at least in part on the input (SAF) packet control data and used to enqueue the input (SAF) packet in one or more SAF packet (control data) queues set up for the same egress port or for the same data buffer allocated for forwarding packets through the egress port on the SAF packet control data path. The SAF queuing data such as the SAF linking data 316 may be relatively heavy weight or of a relatively large size as compared with the CT queuing data 314 for a CT packet.

As used herein, SAF-specific or SAF-only active queue management may refer to management operations performed by the network device/node, including but not limited to: actively managing SAF queues before they become full, avoiding congestion, improving overall performance, etc. These operations may use (e.g., early detection, etc.) algorithms or logics to monitor the state (e.g., size, currently used capacities, etc.) of the queues and take actions to avoid overfilling or overflowing buffers/queues and reduce network congestion (e.g., packet dropping and marking, explicit congestion notification or ECN, avoiding long delays and/or excessive retransmissions, etc.).

SAF-specific or SAF-only admission check as described herein may refer to operations performed in connection with an input SAF packet before allocating resources like buffer space, bandwidth, or processing power in the network device/node for the SAF packet. These operations may be performed to determine whether the input SAF packet can be accepted without violating system constraints (e.g., no available buffer/queue space, leading to congestion, packet loss or excessive delays, fairness or QoS violation, etc.) such as quality of service (QOS), available buffer space, network capacity, etc. In response to determining that the admission check fails for the input SAF packet, the network device/node may reject or drop the packet and/or send a signal back to the sender of the input SAF packet to indicate this admission check failure or packet rejection.

The network device/node or the traffic manager therein may include a scheduler 318—maintaining and operating with packet queues or egress packet queues for an egress port—to manage how packets are processed and forwarded when multiple input packets are waiting to be transmitted through the egress port. The scheduler 318 may be implemented or used to determine a specific temporal order (e.g., to prevent packet re-ordering problems, etc.) in which the input packets from different queues are forwarded through the egress port, helping to optimize performance and fairness in packet forwarding or transmission operations.

In some operational scenarios, a single CT queue may be set up by the traffic manager or the scheduler operating with the traffic manager to schedule transmissions of input CT packets. In comparison, one or more SAF queues may be set up by the traffic manager or the scheduler to schedule transmissions of input SAF packets.

Once the input packet arrives or is received, the traffic manager directs the input packet or input packet control data to be processed in either the CT packet control data path or the SAF packet control data path. The input packet control data or the corresponding queuing/linking data or a reference pointer may be enqueued into different (e.g., CT or SAF, different QoS SAF, different priority SAF, different traffic class/type SAF, etc.) queues set up by the traffic manager or the scheduler 318. For each input packet received, whether it is a SAF or CT packet, the traffic manager or the scheduler 318 may assign an arrival timestamp or arrival timing information indicating when the input packet is received or queued/enqueued into the CT queue or a designated SAF queue of the one or more SAF queues.

In the CT packet control data path, for the CT queue, the scheduler 318 may implement one or more CT dequeuing algorithms to dequeue CT queue elements representing corresponding CT packets. A CT queue element may represent or comprise a CT packet reference/pointer to be used to access or retrieve a CT queuing/linking data portion—denoted as “CT Linking” in FIG. 3A—for a specific CT packet. The CT queuing/linking data portion accessed or retrieved with the CT queue element may represent or comprise a CT packet dequeue to be used to cause or instruct the buffer allocation logic 310 to retrieve some or all input CT packet data (for the specific CT packet) stored in the data buffer 312 of the egress port. The input (or incoming) CT packet data for the specific CT packet may be used to generate output (or outgoing) CT packet data for the specific CT packet. The specific CT packet with the output CT packet data may be transmitted or forwarded by the network device/node through the egress port.

In the SAF packet control data path, for the SAF queues, the scheduler 318 may implement one or more SAF dequeuing algorithms to dequeue SAF queue elements representing corresponding SAF packets. A SAF queue element may represent or comprise an SAF packet reference/pointer to be used to access or retrieve an SAF queuing/linking data portion—denoted as “SAF Linking” in FIG. 3A—for a specific SAF packet. The SAF queuing/linking data portion accessed or retrieved with the SAF queue element may represent or comprise an SAF packet dequeue request to be used to cause or instruct the buffer allocation logic 310 to retrieve some or all input SAF packet data (for the specific SAF packet) stored in the data buffer 312 of the egress port. The input (or incoming) SAF packet data for the specific SAF packet may be used to generate output (or outgoing) SAF packet data for the specific SAF packet. The specific SAF packet with the output SAF packet data may be transmitted or forwarded by the network device/node through the egress port.

The CT dequeuing algorithms implemented by the scheduler may implement a first-come-first-serve dequeuing algorithm to dequeue an (e.g., queue head, etc.) element or generate a CT packet dequeue request from the CT queue for a clock cycle. Additionally, optionally or alternatively, the scheduler may implement an optimistic scheduling algorithm to dequeue any (e.g., queue head, etc.) element present in the CT queue without waiting.

The SAF dequeuing algorithms implemented by the scheduler may include one or more of: a first-come first-served (FCFS) algorithm with which SAF packets are forwarded in the order they arrive in SAF queue(s); a weighted round robin (WRR) with which each of some or all of the SAF queues is assigned a fixed time slot in rotation, but SAF queue(s) with higher priority can be assigned larger time slots; priority scheduling with which packets in higher-priority SAF queue(s) are always processed before lower-priority SAF queue(s), potentially preempting them; deficit round robin (DRR) with which fairness is ensured among some or all of the SAF queues while still maintaining prioritization for time-sensitive traffic; and so on.

As shared resources such as the same egress port and the same data buffer 312 of the egress are being to process and forward CT and SAF network/data packets, CT and SAF packet dequeue requests from the CT and SAF packet control data paths are to be merged with a dequeue request (path) merger or DRPM 320 of FIG. 3A.

FIG. 3B illustrates example packet control data path merging operations performed by the dequeue request (path) merger 320. In some operational scenarios, to support relatively low latency arbitration (e.g., one to three clock cycle latencies, etc.), the merger may set up, maintain or use a store-and-forward request FIFO (SRF) and a cut-through request FIFO (CRF). The merger 320 may be implemented with relatively simple arbitration logic to select the oldest among or between (e.g., current, upcoming, etc.) SRF and CRF heads from the SRF and CRF FIFOs, respectively.

The packet dequeue request (path) merger 320 may be implemented to manage contention between SAF and CT packet dequeue requests such that egress bandwidth (of the egress port) retains a specific bandwidth distribution defined or enforced by the scheduler, latency for forwarding cut-through packets is minimized, and per-port inter-cell jitter is minimized, thereby avoiding or lessening the possibility or occurrence of packet corruption (e.g. underrun, etc.).

As illustrated in FIG. 3B, each CRF or SRF entry in the CRF or SRF FIFO maintained by the DRPM 320 may include (e.g., only, at least, etc.) a buffer address to be used by the buffer allocation logic 310 to access packet data maintained in the data buffer 312 of the egress port for a corresponding CT or SAF network/data packet (or a cell thereof) and a (DRPM) arrival timestamp—captured or assigned by the scheduler—as the dequeue request for the CT or SAF packet (or the cell thereof) depart from the CT or SAF queues maintained by the scheduler 318 and enters the CRF or SRF FIFO maintained by the DRPM 320.

While the same or common scheduler and merger are used for both CT and SAF packet control data path (e.g., along with the buffer allocation logic and data buffer, etc.), the CT packet control path incurs lower latency from the scheduler 318 to DRPM 320. This is due at least in part to the use of relatively simple CT linking structures as compared with SAF linking structures.

In some operational scenarios, on average, (e.g., at most, at least, etc.) one packet dequeue request arrival occurs—e.g., from each or both of the CT and SAF queues maintained by the scheduler 318—to the DRPM 320 per clock cycle. The CRF and SRF FIFOs maintained by the DRPM 320 may be specifically sized or optimized to absorb intermittent bursts due at least in part to differences between SAF and CT packet control data path latencies.

The DRPM 320 may implement an oldest-first arbiter to control departures from the CRF and SRF FIFOs maintained by the DRPM 320. DRPM arrival timestamps—e.g., assigned by the scheduler when delivering CT and SAF dequeue requests to the DRPM 320; CT and SAF entries corresponding to the CT and SAF dequeue requests from the scheduler enqueued at the tail of, and maintained in, the CRF and SRF FIFOs by the DRPM 320—of CRF and SRF heads of the SRF and SRF FIFOs are compared.

If both CRF and SRF heads are present in the CRF and SRF FIFOs, the oldest head among the CRF and SRF heads as indicated by the respective DRPM arrival timestamps is dequeued or selected by the DRPM 320 in a common sequence of packet dequeue requests sent or provided by the DRPM 320 to the buffer allocation logic.

If only one of the CRF and SRF FIFO has data or entry, its head is dequeued and included in the common sequence of packet dequeue requests.

In some operational scenarios, the DRPM 320 enforce a (e.g., I/O resource, timing control, etc.) constraint with which at most one dequeue request may depart from the DRPM 320 to the buffer allocation 310 per (e.g., read, etc.) clock cycle.

In some operational scenarios, dequeue request departure happens if either SRF or CRF FIFO (or both) has data or entries.

After a dequeue request corresponding to the CRF or SRF head (entry) in the CRF or SRF FIFO depart from, or is dispatched by, the DRPM 320 to the buffer allocation logic 310, the CT and SAF packet data control paths merge into the same or common packet control path or sub-path in which same or common packet processing operations such as dequeue control (ctrl) processing 322 (of FIG. 3B) may be performed.

These common packet processing operations may include generating output packet control data, fetching input packet data, generating output packet data, forwarding an output network/data packet corresponding to the input network/data packet, etc. For example, based on the common sequence of merged dequeue requests, the buffer allocation logic 310 can issue read requests (“Data read req” in FIG. 3A) to the data buffer 312 to access or retrieve stored packet data referenced by the address in the dequeued head entry from the CRF or SRF FIFO. Example output packet control data may include, but are not necessarily limited to only, control data used to perform packet header modification (e.g., updating the frame check sequence or FCS, updating VLAN tags, etc.), address resolution (to determine the next hop for forwarding), encapsulation or decapsulation, etc.

FIG. 1, FIG. 2A, FIG. 2B, FIG. 3A and FIG. 3B illustrate representative examples of many possible alternative arrangements of devices configured to provide the functionality described herein. Other arrangements may include fewer, additional, or different components, and the division of work between the components may vary depending on the arrangement. Moreover, in an embodiment, the techniques described herein may be utilized in a variety of computing contexts other than within a network 100 or a network device 200.

Furthermore, figures herein illustrate but a few of the various arrangements of memories that may be utilized to implement the described buffering techniques. Other arrangements may include fewer or additional elements in varying arrangements.

### 6.0. Example Embodiments

Described in this section are various example method flows for implementing various features of the systems and system components described herein. The example method flows are non-exhaustive. Alternative method flows and flows for implementing other features will be apparent from the disclosure.

The various elements of the process flows described below may be performed in a variety of systems, including in one or more computing or networking devices that utilize some or all of the load balancing or traffic distribution mechanisms described herein. In an embodiment, each of the processes described in connection with the functional blocks described below may be implemented using one or more integrated circuits, logic components, computer programs, other software elements, and/or digital logic in any of a general-purpose computer or a special-purpose computer, while performing data retrieval, transformation, and storage operations that involve interacting with and transforming the physical state of memory of the computer.

FIG. 4 illustrates an example process flow, according to an embodiment. The various elements of the flow described below may be performed by one or more network devices (or processing engines therein) implemented with one or more computing devices. In block 402, a network device as described herein or a traffic manager therein allocates a common packet data buffer for an egress port to store incoming packet data that includes both CT packets and SAF packets. The CT packets and the SAF packets are to be forwarded out of the same egress port.

In block 404, the traffic manager directs SAF packet control data of the SAF packets upon receipt onto a control data path defined by a first plurality of processing engines. The SAF control data are to arrive at a scheduling logic engine with a first latency after processing by the first plurality of processing engines.

In block 406, the traffic manager directs CT packet control data of the CT packets upon receipt onto a second control data path. The CT control data are to arrive at the scheduling logic engine with a second latency that is less than the first latency after processing in the second control path by a second plurality of processing engines that bypasses at least one or more processing engines among the first plurality of processing engines.

In block 408, the traffic manager generates CT packet dequeue requests for the CT packets using the CT packet control data and generating SAF dequeue requests for the SAF packets using the SAF packet control data.

In block 410, the traffic manager merges the CT packet dequeue requests and the SAF dequeue requests into a merged sequence of dequeue requests.

In block 412, the traffic manager retrieves packet data from the common packet data buffer based on the merged sequence of dequeue requests.

In an embodiment, the control data path includes, and the second control data path excludes, performing one or more of: active queue management operations relating to the one or more SAF queues, or SAF admission check operations.

In an embodiment, the traffic manager further performs: in response to receiving an incoming packet, determining whether the incoming packet is eligible as a CT packet.

In an embodiment, the scheduling logic engine assigns first arrival timestamps of the CT packet control data of the CT packets to the CT packets and assigns second arrival timestamps of the SAF packet control data of the SAF packets to the SAF packets.

In an embodiment, the scheduling logic engine compares a first arrival timestamp of a CT packet control data portion of a CT packet enqueued in the single CT queue with a second arrival timestamp of a selected SAF packet control data portion of a selected SAF packet enqueued in the one or more SAF queues for selecting one of a CT dequeue request or a SAF dequeue request to generate a read request during a given read clock cycle.

In an embodiment, the merged sequence of dequeue requests incurs a single data read request to the common packet data buffer each data unit of a CT or SAF packet to be forwarded out of the egress port.

In an embodiment, the scheduling logic engine and merging logic engine are implemented with a traffic manager of a networking device.

In an embodiment, a computing device such as a switch, a router, a line card in a chassis, a network device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### 7.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the inventive subject matter have been described with reference to numerous specific details that may vary from implementation to implementation. Thus, the sole and exclusive indicator of what is the inventive subject matter, and is intended by the applicants to be the inventive subject matter, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for processing cut-through (CT) and store-and-forward (SAF) traffic, the method comprising:
allocating a common packet data buffer for an egress port to store incoming packet data that includes both CT packets and SAF packets, wherein the CT packets and the SAF packets are to be forwarded out of the same egress port;
directing SAF packet control data of the SAF packets upon receipt onto a control data path defined by a first plurality of processing engines, the SAF control data to arrive at a scheduling logic engine with a first latency after processing by the first plurality of processing engines;
directing CT packet control data of the CT packets upon receipt onto a second control data path, the CT control data to arrive at the scheduling logic engine with a second latency that is less than the first latency after processing in the second control path by a second plurality of processing engines that bypasses at least one or more processing engines among the first plurality of processing engines;
generating CT packet dequeue requests for the CT packets using the CT packet control data and generating SAF dequeue requests for the SAF packets using the SAF packet control data;
merging the CT packet dequeue requests and the SAF dequeue requests into a merged sequence of dequeue requests; and
retrieving packet data from the common packet data buffer based on the merged sequence of dequeue requests.

2. The method of claim 1, wherein the control data path includes, and the second control data path excludes, performing one or more of: active queue management operations relating to the one or more SAF queues, or SAF admission check operations.

3. The method of claim 1, further comprising: in response to receiving an incoming packet, determining whether the incoming packet is eligible as a CT packet.

4. The method of claim 1, wherein the scheduling logic engine assigns first arrival timestamps of the CT packet control data of the CT packets to the CT packets and assigns second arrival timestamps of the SAF packet control data of the SAF packets to the SAF packets.

5. The method of claim 1, wherein the scheduling logic engine compares a first arrival timestamp of a CT packet control data portion of a CT packet enqueued in the single CT queue with a second arrival timestamp of a selected SAF packet control data portion of a selected SAF packet enqueued in the one or more SAF queues, and in response to the comparison, select one of a CT dequeue request or a SAF dequeue request and generate a read request during a given read clock cycle.

6. The method of claim 1, wherein the merged sequence of dequeue requests incurs a single data read request to the common packet data buffer each data unit of a CT or SAF packet to be forwarded out of the egress port.

7. The method of claim 1, wherein a traffic manager includes the scheduling logic engine configured to perform enqueuing and dequeuing operations on both CT and SAF incoming packets for forwarding and a merging logic engine configured to receive CT and SAF dequeue requests from the scheduling logic engine and merge the CT and SAF dequeue requests into the common sequence of dequeue requests.

8. A network switching system, comprising:
a buffer manager configured to allocate a common packet data buffer for an egress port to store incoming packet data that includes both CT packets and SAF packets, wherein the CT packets and the SAF packets are to be forwarded out of the same egress port and to retrieve packet data from the common packet data buffer based on a merged sequence of dequeue requests;
an ingress packet processor configured to direct SAF packet control data of the SAF packets upon receipt onto a control data path defined by a first plurality of processing engines, the SAF control data to arrive at a scheduling logic engine with a first latency after processing by the first plurality of processing engines;
wherein the ingress packet processor is further configured to direct CT packet control data of the CT packets upon receipt onto a second control data path, the CT control data to arrive at the scheduling logic engine with a second latency that is less than the first latency after processing in the second control path by a second plurality of processing engines that bypasses at least one or more processing engines among the first plurality of processing engines;
a scheduling logic engine configured to generate CT packet dequeue requests for the CT packets using the CT packet control data and to generate SAF dequeue requests for the SAF packets using the SAF packet control data; and
a merging logic engine configured to merge the CT packet dequeue requests and the SAF dequeue requests into the merged sequence of dequeue requests.

9. The system of claim 8, wherein the ingress packet processor is configured to perform one or more of: active queue management operations relating to the one or more SAF queues, or SAF admission check operations, that are included in the data path but excluded from the second data path.

10. The system of claim 8, wherein the instructions that, when executed by the one or more computing devices, further cause performance of: in response to receiving an incoming packet, determining whether the incoming packet is eligible as a CT packet.

11. The system of claim 8, wherein the scheduling logic engine is configured to assign first arrival timestamps of the CT packet control data of the CT packets to the CT packets and to assign second arrival timestamps of the SAF packet control data of the SAF packets to the SAF packets.

12. The system of claim 8, wherein the scheduling logic engine is configured to compare a first arrival timestamp of a CT packet control data portion of a CT packet enqueued in the single CT queue with a second arrival timestamp of a selected SAF packet control data portion of a selected SAF packet enqueued in the one or more SAF queues, and in response to the comparison, select one of a CT dequeue request or a SAF dequeue request and, during a given read clock cycle, generate a read request based on the selected CT or SAF dequeue request.

13. The system of claim 8, wherein the buffer manager is configured to process the merged sequence of dequeue requests that incurs a single data read request to the common packet data buffer each data unit of a CT or SAF packet to be forwarded out of the egress port.

14. The system of claim 8, wherein the system further comprises a traffic manager that includes the scheduling logic engine configured to perform enqueuing and dequeuing operations on both CT and SAF incoming packets for forwarding and the merging logic engine is configured to receive CT and SAF dequeue requests from the scheduling logic engine and to merge the CT and SAF dequeue requests into the common sequence of dequeue requests.
